(19) United States
(12) Patent Application Publication
(10) Pub. No.: US 2008/0254879 A1
(43) Pub. Date: Oct. 16, 2008

(54) Video game apparatus, video game control method, and video game control program

(76) Inventor: Shinji Motoyama, Tokyo (JP)

Correspondence Address: LADAS & PARRY LLP, 224 SOUTH MICHIGAN AVENUE, SUITE 1600, CHICAGO, IL, 60604, US

(21) Appl. No.: 11/518,761

(22) Filed: Sep. 11, 2006

(30) Foreign Application Priority Data
Sep. 9, 2005 (JP) 2005-262824

(51) Int. Cl. G06F 17/00

(52) U.S. Cl. 463/31; 463/36

(57) ABSTRACT

A video game controlling technique is disclosed that involves controlling the game progress based on player operations, determining win/loss based on input speed and/or input number of player operation inputs, detecting the start of a consecutive hitting event, detecting a parameter indicating the game status at the time the start of the consecutive hitting event is detected, determining a winning condition corresponding to an input speed and/or input number for winning in the consecutive hitting event, determining win/loss based on the determined winning condition, and changing a predetermined parameter related to the game progress so that the winner may be given an advantage over the loser.

### BACKGROUND OF THE INVENTION

1. Field of the Invention

The present invention relates to a video game apparatus, a video game control method, and a video game control program.

2. Description of the Related Art

Winning or losing in a video game may be determined from various aspects. It is noted that such an event is not limited to simple match games, and may also be incorporated in a RPG (role playing game) or a SLG (simulation game), for example.

A so-called “consecutive hits rule” is one simple means for determining an outcome (win/loss) of a game. According to this rule, a winner or a loser may be determined from plural players or a player and a CPU (central processing unit) based on the number of times a button is consecutively hit by the players. The consecutive hits rule is a simple rule that determines a win/loss based on the number of consecutive hits made and is therefore easy to understand even for beginner players. For example, PCT International Publication WO98/43715 discloses a technique for determining a win or a loss based on the number of consecutive hits as an inserted event while a game is in progress.

Although the consecutive hits rule is simple and easy to understand, it does not take into consideration factors leading up to the current situation (e.g., the level of individual parameters, advantageous/disadvantageous statuses based on positioning, etc.). Therefore, such a rule may be inadequate for determining the outcome of a game. Specifically, the statuses of game characters and the circumstances leading up to the start of the consecutive hits match may not be taken into consideration, and the match outcome may simply be a matter of contesting the speed of hitting a button under equal conditions according to the consecutive hits rule. In other words, since the consecutive hits rule disregards game tactics such as starting the match at an advantageous position, or intentionally starting the match from a disadvantageous position but winning over the opponent from such a position, for example, a match based on such a rule may not be very interesting.

Also, it is noted that games into which the consecutive hits rule may be incorporated are relatively limited. For example, in games that involve thinking such as the RPG or SLG, since the game essence lies in the thought process for reaching a current situation, awkwardness may be created when elements of the game progress are not considered. A similar problem may arise when the consecutive hits rule is incorporated in a puzzle game or an adventure game, for example.

It is noted that the pace at which a thinking game such as the RPG and the SLG is played may be relatively slow. On the other hand, games that are presently in demand are generally up-tempo and easily maneuvered even by beginners. Such games may generally be played without thinking and include a substantial amount of action. Accordingly, the consecutive hits rule may be suitably applied to current games owing to its up-tempo and simple features. However, the consecutive hits rule has the problems as is described above so that its incorporation into certain games may create inconveniences.

### SUMMARY OF THE INVENTION

According to an aspect of the present invention, a technique is provided for incorporating various aspects of a game as criteria for superiority determination in a simple win/loss determining system to arouse sufficient interest and excitement in the game, and enabling the system to be used in a wider range of games.

According to an embodiment of the present invention, a video game apparatus is provided that includes:

an input unit that receives a player operation input;

a game progress control unit that controls a game progress based on an input signal from the input unit;

a consecutive hitting input detecting unit that detects at least one of the speed at which the input signal is input or the number of times the input signal is input;

a consecutive hitting event control unit that determines the win/loss outcome of a match between a player and an opponent in a consecutive hitting event based on at least one of the speed at which the input signal is input and the number of times the input signal is input;

a consecutive hitting event detecting unit that monitors the game progress and detects the start of the consecutive hitting event;

a parameter detecting unit that detects a parameter indicating the game status at the time the consecutive hitting event detecting unit detects the start of the consecutive hitting event, the parameter being used to determine superiority/inferiority of the player and the opponent in the consecutive hitting event;

a consecutive hitting number determining unit that determines for each of the player and the opponent a winning condition corresponding to at least one of the input speed for inputting the input signal and the input number of the input signal for winning the match in the consecutive hitting event;

a consecutive hitting event win/loss processing unit that determines the win/loss outcome in the consecutive hitting event based on the winning condition determined by the consecutive hitting number determining unit, and changes a predetermined parameter related to the game progress so that one of either the player or the opponent that is determined to be a winner is given advantage over the other one of the player or the opponent that is determined to be a loser; and

a display control unit that generates screen data according to the game progress and outputs the generated screen data to a display.

In one preferred embodiment of the present invention, the consecutive hitting event detecting unit detects the start of the consecutive hitting event when collisions for attacking are issued from game characters corresponding to the player and the opponent and the collisions come into contact with each other, the opponent being another player or a CPU.

In another preferred embodiment of the present invention, the parameter detecting unit detects a proportional distance of a contact position of the collisions with respect to positions of the game characters.

In another preferred embodiment of the present invention, the consecutive hitting number determining unit determines a consecutive hitting number as the winning condition for each of the player and the opponent by increasing/decreasing a consecutive hitting base number according to the proportional distance of the contact position of the collisions.

In another preferred embodiment of the present invention, the parameter detecting unit detects at least one of a parameter related to game characters corresponding to the player and the opponent, an operation timing, and information pertaining to an environment in which the game characters are situated as the parameter indicating the game status.

According to another embodiment of the present invention, a video game apparatus is provided that includes:

an input unit that receives a player operation input;

a detecting unit that detects that an operation input requesting condition has been satisfied for starting a win/loss determination by operation input based on a predetermined input condition and a predetermined winning condition;

a norm setting information detecting unit that detects norm setting information that is based on a game progress at the time the detecting unit determines that the operation input requesting condition has been satisfied;

a determining unit that adjusts at least one of the predetermined input condition and the predetermined winning condition based on the norm setting information detected by the norm setting information detecting unit and determines at least one of an input condition and a winning condition;

a game progress control unit that controls the game progress including a win/loss determination based on the determined input condition or winning condition; and

a display control unit that generates screen data according to the game progress and outputs the generated screen data to a display.

According to another embodiment of the present invention, a video game control method is provided that includes the steps of:

inputting a player operation input;

controlling a game progress based on an input signal generated in the inputting step;

detecting at least one of a speed at which the input signal is input and a number of times the input signal is input;

determining a win/loss outcome of a match between a player and an opponent in a consecutive hitting event based on at least one of the speed at which the input signal is input and the number of times the input signal is input;

monitoring the game progress and detecting the start of the consecutive hitting event;

detecting a parameter indicating the game status at the time the start of the consecutive hitting event is detected, the parameter being used to determine superiority/inferiority of the player and the opponent in the consecutive hitting event;

determining for each of the player and the opponent a winning condition corresponding to at least one of the input speed for inputting the input signal and the input number of the input signal for winning the match in the consecutive hitting event;

determining the win/loss outcome in the consecutive hitting event based on the determined winning condition and changing a predetermined parameter related to the game progress so that one of either the player or the opponent that is determined to be a winner is given advantage over the other one of the player or the opponent that is determined to be a loser; and

generating screen data according to the game progress and outputting the generated screen data to a display.

According to another embodiment of the present invention, a video game control method is provided that includes the steps of:

inputting a player operation input;

detecting that an operation input requesting condition has been satisfied for starting a win/loss determination by operation input based on a predetermined input condition and a predetermined winning condition;

detecting norm setting information that is based on the game progress at the time of detecting that the operation input requesting condition has been satisfied;

adjusting at least one of the predetermined input condition and the predetermined winning condition based on the detected norm setting information and determining at least one of an input condition and a winning condition;

controlling the game progress including a win/loss determination based on at least one of the determined input condition and the determined winning condition; and

generating screen data according to the game progress and outputting the generated screen data to a display.

According to another embodiment of the present invention, a computer-readable program for controlling a vide game is provided that is executed by a computer to perform a video control method according to an embodiment of the present invention.

### BRIEF DESCRIPTION OF THE DRAWINGS

FIG. 1 is a block diagram showing a configuration of a video game apparatus according to an embodiment of the present invention;

FIG. 2 is a diagram illustrating an exemplary relationship between an interfering position of collisions and stipulated consecutive hit number values;

FIG. 3 is a flowchart illustrating exemplary process steps that may be performed by the video game apparatus of FIG. 1;

FIG. 4 is a diagram showing an exemplary screen illustrating a collision being issued from one game character;

FIG. 5 is a diagram showing an exemplary screen illustrating energy accumulation for generating a collision;

FIG. 6 is a diagram showing an exemplary screen illustrating paralysis of a game character as a result of being hit by a collision;

FIG. 7 is a diagram showing a screen illustrating collisions interfering with each other; and

FIG. 8 is a diagram showing a screen illustrating a win/loss determination according to the consecutive hits rule.

### DETAILED DESCRIPTION OF THE PREFERRED EMBODIMENTS

In the following, preferred embodiments of the present invention are described with reference to the accompanying drawings.

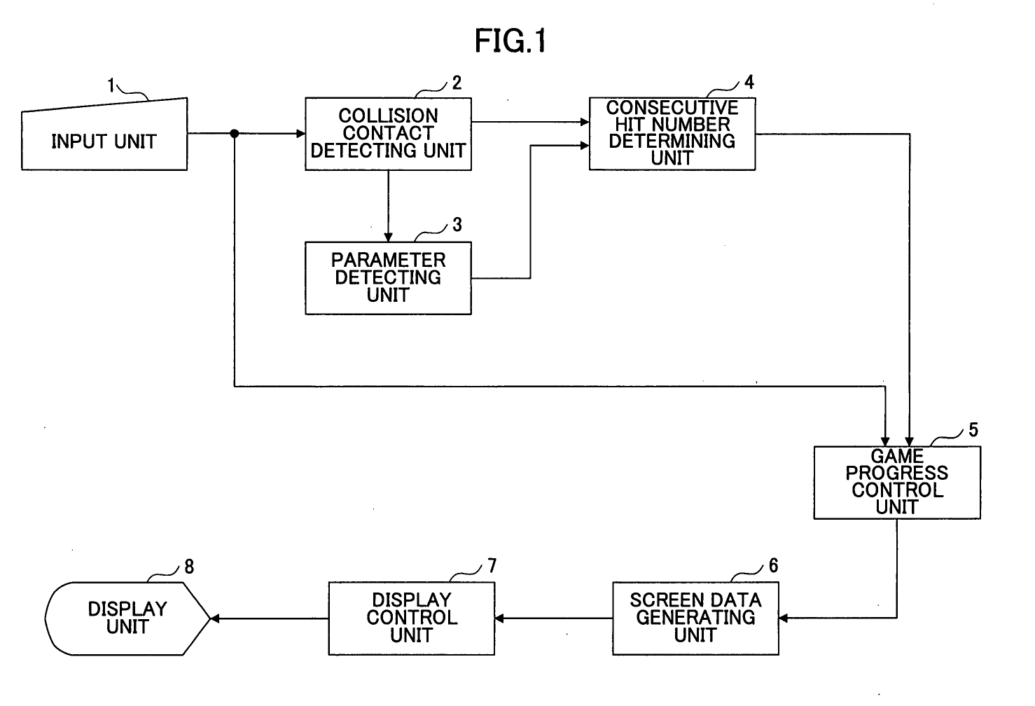

FIG. 1 is a block diagram showing an exemplary configuration of a video game apparatus according to an embodiment of the present invention. It is noted that embodiments of the present invention may be applied to a variety of video game apparatuses including domestic/business-oriented video game apparatuses, for example. Also, a video game apparatus according to an embodiment of the present invention maybe located within a household, at an amusement (AM) facility, or at any other suitable location, for example.

The illustrated video game apparatus of FIG. 1 includes an input unit 1 that may be a button switch that receives operation inputs from a player; a collision contact detecting unit 2 that detects contact of collisions (e.g., images in various shapes and forms such as a concentric circle or a dome shape) that are issued as attacks from game characters each controlled by opposing players or a player and a CPU, the collision contact representing the start of a win/loss determination according to the consecutive hits rule; a parameter detecting unit 3 that detects a parameter indicating the game status when the collision contact detecting unit 2 detects the start of a win/loss determination according to the consecutive hits rule; and a consecutive hit number determining unit 4 that determines the number of consecutive hits according to the parameter detected by the parameter detecting unit 3. The video game apparatus of the present embodiment also includes a game progress control unit 5 that controls the game progress including the win/loss determination according to the consecutive hits rule based on the number of consecutive hits determined by the parameter detecting unit 3; a screen data generating unit 6 that generates screen data in accordance with the game progress; a display control unit 7 that controls display of the generated screen data; and a display unit 8 that displays the generated screen data. It is noted that in one preferred embodiment, the collision contact detecting unit 2, the parameter detecting unit 3, the consecutive hit number determining unit 4, the game progress control unit 5, the screen data generating unit 6, and the display control unit 7 may primarily be embodied by software (computer programs).

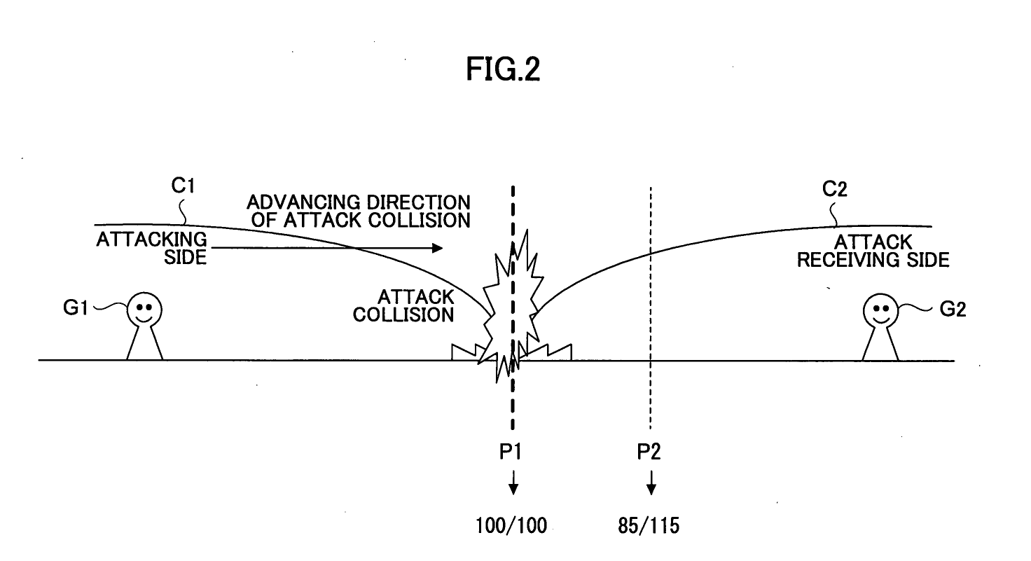

FIG. 2 is a diagram illustrating a relationship between the interfering position of collisions and stipulated consecutive hit number values. Specifically this drawing illustrates a case in which a game character G1 issues a collision C1 that is referred to as “attack”, and a game character G2 issues a collision C2 in response to this “attack” as a counterattack. In the illustrated example, the ratio of the distance between the positions of the game characters G1 and G2 to the distance between the interfering position P1 at which the collisions C1 and C2 come into contact (interfere) and the position of the game character G2 receiving the “attack” is detected as the parameter indicating the game status. For example, assuming that the consecutive hit base number is 100, if the interfering position is at position P1 (where the parameter ratio is 50%), it may be determined that the game characters are on equal terms, and the value 100 may be the stipulated consecutive hit number value for both the attacking game character G1 and the attack receiving game character G2. On the other hand, in a case where the interfering position of the collisions C1 and C2 is at position P2 that is closer to the attack receiving game character G2, it may be determined that the attacking game character G1 has the upper hand, and in turn, the value 85 maybe the stipulated consecutive hit number value for the attacking game character G1 and the value 115 may be the stipulated consecutive hit number value for the attack receiving game character G2, for example. It is noted that the present example is based on the principle that the attack receiving game character G2 will be worse off the more the issuance of the counterattack collision C2 by the attack receiving game character G2 against the attack collision C1 is delayed. However, the present example also relies on the principle that the attack receiving game character G2 may gain the upper hand by waiting for the attack collision C1 to come closer to its position and striking at an appropriate position in which case the proportional relation of the stipulated consecutive hit number values for the game characters G1 and G2 may be reversed.

It is noted that the parameter used for determining the game status is not limited to the proportional distance of the collision interfering position as is described above, and other factors such as those listed below may also be used, for example.

### <Game Character Parameter-Related>

“Remaining spirit pressure” of game character (“spirit pressure” denotes energy for issuing collisions)

“Consumed spirit pressure” of game character

“Attacking power” of game character

Attributes such as “origin” of game character

### <Time-Related>

Remaining time

Order of issuance

### <Other Environment-Related>

If plural game characters exist, the order in which they are activated

Direction of game character

Attributes related to geographical features of location at which game character is positioned

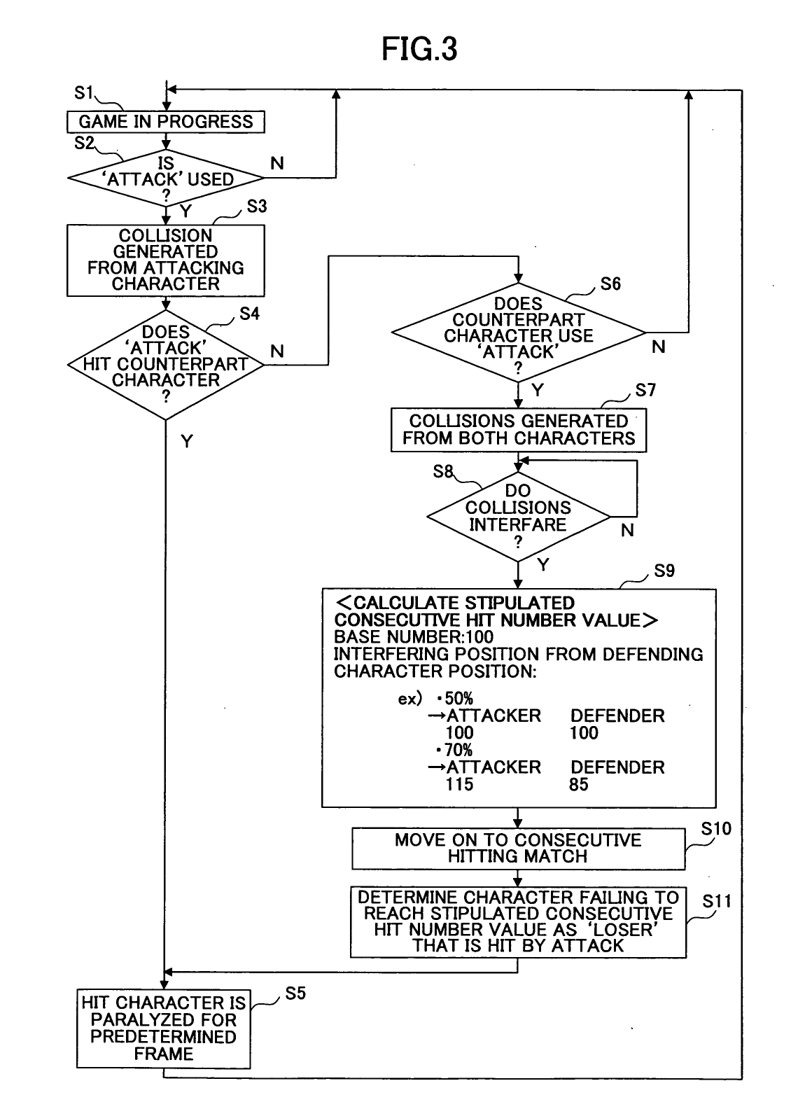

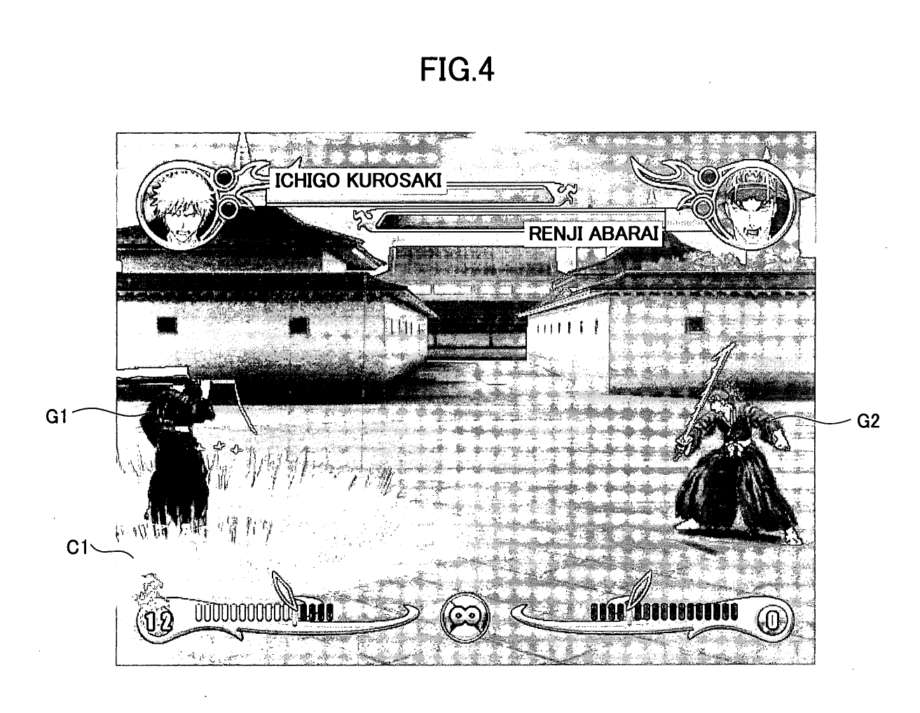

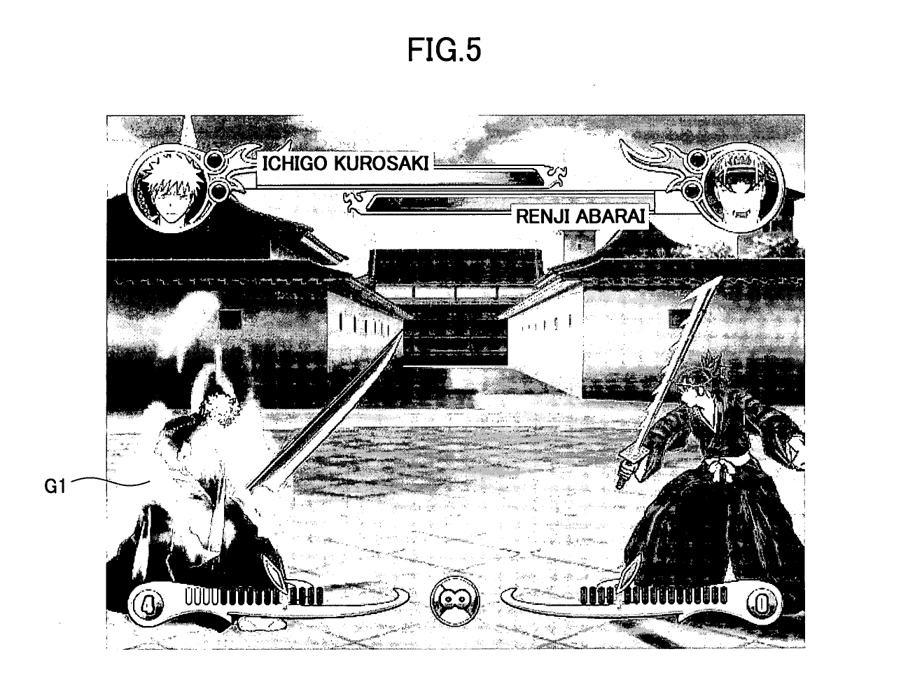

FIG. 3 is a flowchart illustrating process steps that may be executed by the video game apparatus of FIG. 1. According to FIG. 3, while a game is in progress (step S1), a determination is made as to whether a collision generation “attack” is used (step S2). If such an “attack” is not used (step S2, N), the process goes back to step S1. If an “attack” is used (step S2, Y), a collision is generated from the game character using the “attack” (step S3). FIG. 4 shows an exemplary screen illustrating a case in which a concentric collision C1 is issued from one game character G1. It is noted that energy referred to as “spiritual pressure” is stored beforehand to generate a collision. FIG. 5 is shows an exemplary screen illustrating a case in which the game character G1 is performing “spiritual pressure accumulation”.

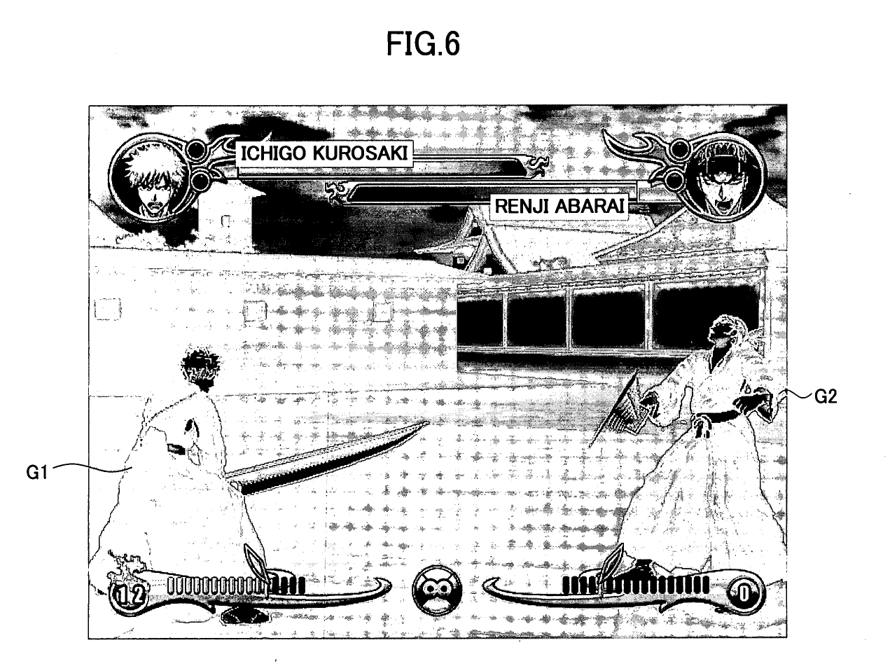

Referring back to FIG. 3, a determination is made as to whether the collision of the “attack” has hit the counterpart character (step S4). If the “attack” has hit the counterpart character (step S4, Y), the counterpart character is paralyzed for a predetermined frame such as 120 frames (i.e., actions of the character are invalidated during the corresponding frame) (step S5). FIG. 6 shows an exemplary screen illustrating the paralysis of a game character that is hit by a collision. Specifically the game character G2 is in a state of paralysis as a result of being hit by the collision C1 issued by the game character G1.

Referring back to FIG. 3, after a game character is paralyzed for a predetermined frame as a result of being hit by a collision (step S5), the process goes back to step S1.

On the other hand, in a case where the collision of the “attack” does not hit the counterpart game character (step S4, N), a determination is made as to whether the counterpart game character also uses a collision “attack” (step S6). If the counterpart game character does not use the “attack” (step S6, N), the process goes back to step S1.

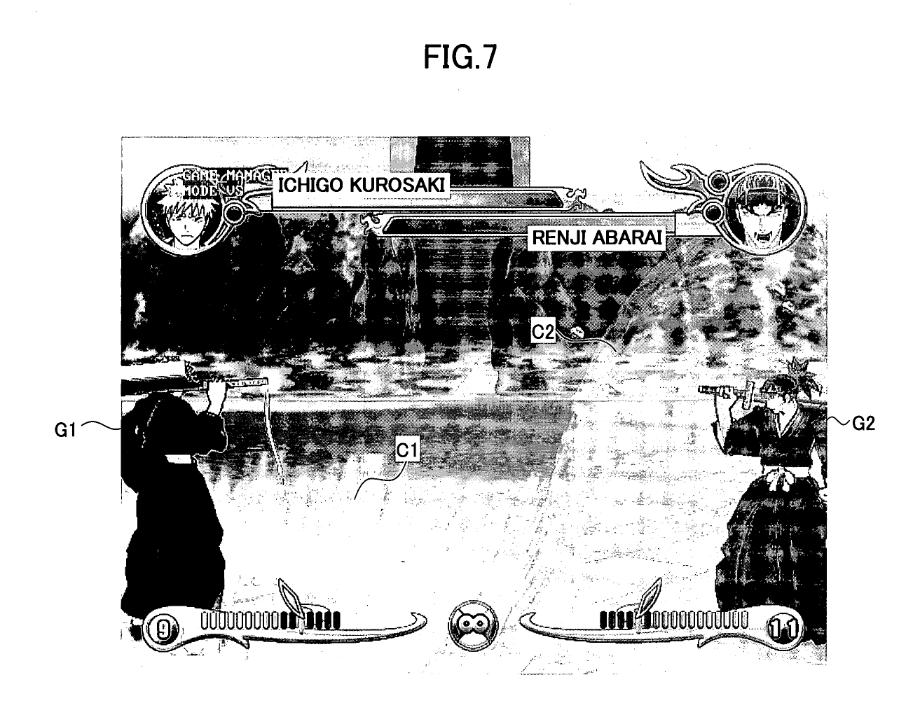

If the counterpart game character also issues a collision “attack” (step S6, Y), collisions are generated from both game characters (step S7). For example, FIG. 7 shows an exemplary screen illustrating a case in which a concentric collision C1 is issued from the game character G1 and a dome-shaped collision C2 is issued from the game character G2.

Referring back to FIG. 3, a determination is made as to whether the collisions generated by the game characters come into contact (interfere) with each other (step S8). If it is determined that the collisions are not interfering with each other (step S8, N), the determination step S8 is repeated until the interference between the collisions is detected. When the collisions interfere with each other (step S8, Y), the stipulated consecutive hit number values are calculated (step S9). For example, assuming that the consecutive hit base number is 100, when the distance of the collision interfering position from the defending game character position is 50% of the distance between the attacking game character and the defending game character, the stipulated consecutive hit number value for the attacking game character may be 100, and the stipulated consecutive hit number value for the defending game character may also be 100. When the distance of the collision interfering position is 70%, the stipulated consecutive hit number value for the attacking game character may be 115, and the stipulated consecutive hit number value for the defending game character may be 85, for example.

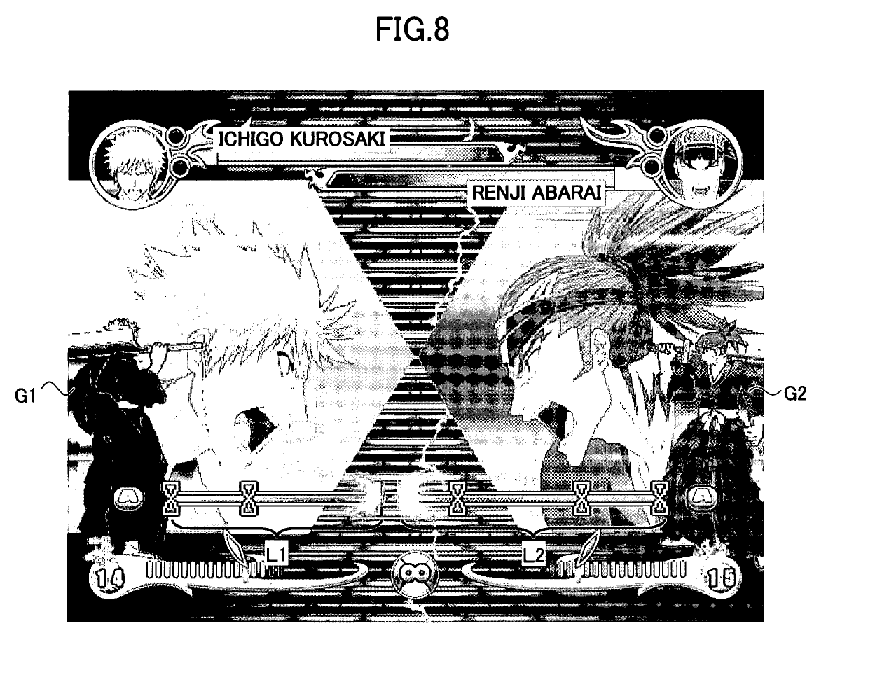

Then, the process moves on to a win/loss determination according to the consecutive hits rule (consecutive hitting match referred to as “spiritual pressure match”) (step S10), and the match ends when the number of consecutive hits made by one of the players (or either the CPU or the contesting player) controlling one of the game characters reaches the corresponding stipulated consecutive hit number value. FIG. 8 shows an exemplary screen illustrating a win/loss determination according to the consecutive hits rule. In the illustrated screen, enlarged images showing the faces of the game characters G1 and G2 are displayed in the background, and lengths L1 and L2 corresponding to the stipulated consecutive hit number values for the game characters G1 and G2 at the start of the consecutive hitting match are displayed. Then, gauges indicating the transitions in the number of consecutive hits made are displayed. In the present example, by winning the “spiritual pressure match”, the actions of the counterpart game character may be unconditionally invalidated for a relatively long period of time. Accordingly, the match is a high-risk-high-return game event in which both the game character issuing the “attack” and the game character receiving the “attack” make desperate attempts to win the match.

Referring back to FIG. 3, the game character that fails to make a number of consecutive hits reaching the stipulated consecutive hit number value is determined to be the loser, and the attack hits the losing game character (step S11). In turn, the game character hit by the attack is paralyzed (step S5). In one embodiment, the match outcome may be determined to be a draw when the win/loss determination cannot be made. In this case both game characters may be hit by the “attack”, for example.

In the following, a more generalized embodiment of the present invention is described. According to this embodiment, the “win/loss determination according to the consecutive hits rule” as is described above may be an example of a “win/loss determination by operation input based on predetermined input condition and winning condition”. In this case, the collision contact detecting unit 2 of FIG. 1 may be an example of a “detecting unit that detects that an operation input requesting condition has been satisfied for starting a win/loss determination by operation input based on a predetermined input condition and a predetermined winning condition”, and the parameter detecting unit 3 of FIG. 1 may be an example of a “norm setting information detecting unit that detects norm setting information that is based on a game progress status at the time the detecting unit detects that the operation input requesting condition has been satisfied”. The consecutive hit number determining unit 4 of FIG. 1 may be an example of a “determining unit that adjusts at least one of the predetermined input condition and the predetermined winning condition according to the norm setting information detected by the norm setting information detecting unit and determines at least one of an input condition and a winning condition”.

It is noted that the “operation input requesting condition” may be any one of the items listed below, for example.

Interference (contact) of the collisions that are generated by opposing game characters

One or both of the game characters moving into a predetermined position within the game space

The game character controlled by a player moving into a predetermined position within the game space or an operation input being made to induce such an effect in a case where the win/loss determination is not a match-up game

Also, the “norm setting information” may be any one of the items listed below, for example.

Information on the relative position of the interfering position of the collisions generated by opposing game characters with respect to the positions of the game characters, namely, information indicating which of the opposing game characters is positioned closer to the interfering position

Character environment information such as the positions of the opposing game characters within the game space

Information on comparison of at least one performance parameter of opposing characters (e.g., feature, attributes, energy level, etc.)

Also, the “input condition” may be any one of the items listed below, for example.

Input operation involving consecutively hitting one or more predetermined buttons with accuracy for a predetermined number of times or at a predetermined speed (consecutive hitting)

Input operation involving turning a directional lever (lever switch) around or back and forth with accuracy for a predetermined number of times or at a predetermined speed

Input operation involving continually rolling a track ball or a mouse with accuracy for a predetermined number of times or at a predetermined speed

Operation involving inputting a predetermined command (i.e., a combination of plural differing operation inputs in a predetermined order) at least once with accuracy (in this case, special arrangements may be made with respect to a game character that is determined to have the upper hand; for example, the limited time during which such a command may be accepted may be increased (i.e., the command may be input at a slower pace) the command input number norm may be decreased, or the command to be input may be simplified (e.g., a simpler command such as that with a smaller number of combined operation inputs may be selected from plural defined commands and indicated as the norm))

Also, the “winning condition” may be any one of the items listed below, for example.

The game character that is faster at inputting a predetermined operation input within a predetermined time period for a predetermined number of times is determined to be the winner

The game character that inputs a greater number of operation inputs within a predetermined time period is determined to be the winner

The winner is determined based on accuracy and speed; for example, the winner may be determined based on the number of times an input is accurately made and the number of times the input is inaccurately made

As can be appreciated from the above descriptions, by incorporating various aspects of a game as criteria for superiority determination, adequate interest may be aroused even when employing a simple system such as a win/loss determination system based on the consecutive hitting of a button, and the win/loss determination system, of which application has been limited to certain games, may be used in a wider range of games. In other words, the simplicity of the game may be maintained while encouraging a player to employ tactics such as gaining the upper hand at the start of a win/loss determination or intentionally starting off from a disadvantageous position but winning over the opponent in the end, for example. Also, a system according to an embodiment of the present invention may be applied to games that require thinking that may be enjoyed by advanced players such as an RPG or an SLG. Further, by incorporating a system according to an embodiment of the present invention in a thinking game such as an RPG or an SLG, which tends to proceed at a slow pace, up-tempo properties, action, and other features appreciated by beginner players may be added to the game to thereby improve playability. By incorporating such a system in a game, rules that have tended to be complicated may be simplified so that the game may be enjoyed by beginners, and at the same time, since features such as superiority determination are incorporated, an advanced player may have the chance to comprehensively consider various aspects of the game and put much thought into his/her game-play, for example.

Although the present invention is shown and described with respect to certain preferred embodiments, it is obvious that equivalents and modifications will occur to others skilled in the art upon reading and understanding the specification. The present invention includes all such equivalents and modifications, and is limited only by the scope of the claims.

The present application is based on and claims the benefit of the earlier filing date of Japanese Patent Application No. 2005-262824 filed on Sep. 9, 2005, the entire contents of which are hereby incorporated by reference.

What is claimed is:

1. A video game apparatus, comprising:
an input unit that receives a player operation input;
a game progress control unit that controls a game progress based on an input signal from the input unit;
a consecutive hitting input detecting unit that detects at least one of a speed at which the input signal is input or a number of times the input signal is input;
a consecutive hitting event control unit that determines a win/loss outcome of a match between a player and an opponent in a consecutive hitting event based on at least one of the speed at which the input signal is input and the number of times the input signal is input;
a consecutive hitting event detecting unit that monitors the game progress and detects a start of the consecutive hitting event;
a parameter detecting unit that detects a parameter indicating a game status at the time the consecutive hitting event detecting unit detects the start of the consecutive hitting event, the parameter being used to determine superiority/inferiority of the player and the opponent in the consecutive hitting event;
a consecutive hitting number determining unit that determines for each of the player and the opponent a winning condition corresponding to at least one of an input speed for inputting the input signal and an input number of the input signal for winning the match in the consecutive hitting event;
a consecutive hitting event win/loss processing unit that determines the win/loss outcome in the consecutive hitting event based on the winning condition determined by the consecutive hitting number determining unit and changes a predetermined parameter related to the game progress so that one of either the player or the opponent that is determined to be a winner is given advantage over the other one of the player or the opponent that is determined to be a loser; and
a display control unit that generates screen data according to the game progress and outputs the generated screen data to a display.

2. The video game apparatus as claimed in claim 1, wherein
the consecutive hitting event detecting unit detects the start of the consecutive hitting event when collisions for attacking are issued from game characters corresponding to the player and the opponent and the collisions come into contact with each other, the opponent being another player or a CPU.

3. The video game apparatus as claimed in claim 2, wherein
the parameter detecting unit detects a proportional distance of a contact position of the collisions with respect to positions of the game characters.

4. The video game apparatus as claimed in claim 3, wherein
the consecutive hitting number determining unit determines a consecutive hitting number as the winning condition for each of the player and the opponent by increasing/decreasing a consecutive hitting base number according to the proportional distance of the contact position of the collisions.

5. The video game apparatus as claimed in claim 1, wherein
the parameter detecting unit detects at least one of a parameter related to game characters corresponding to the player and the opponent, an operation timing, and information pertaining to an environment in which the game characters are situated as the parameter indicating the game status.

6. A video game apparatus, comprising:
an input unit that receives a player operation input;
a detecting unit that detects that an operation input requesting condition has been satisfied for starting a win/loss determination by operation input based on a predetermined input condition and a predetermined winning condition;
a norm setting information detecting unit that detects norm setting information that is based on a game progress at the time the detecting unit determines that the operation input requesting condition has been satisfied;
a determining unit that adjusts at least one of the predetermined input condition and the predetermined winning condition based on the norm setting information detected by the norm setting information detecting unit and determines at least one of an input condition and a winning condition;
a game progress control unit that controls the game progress including a win/loss determination based on said at least one of the input condition and the winning condition determined by the determining unit; and
a display control unit that generates screen data according to the game progress and outputs the generated screen data to a display.

7. A video game control method, comprising the steps of:
inputting a player operation input;
controlling a game progress based on an input signal generated in the inputting step;
detecting at least one of a speed at which the input signal is input and a number of times the input signal is input;
determining a win/loss outcome of a match between a player and an opponent in a consecutive hitting event based on at least one of the speed at which the input signal is input and the number of times the input signal is input;
monitoring the game progress and detecting a start of the consecutive hitting event;
detecting a parameter indicating a game status at the time the start of the consecutive hitting event is detected, the parameter being used to determine superiority/inferiority of the player and the opponent in the consecutive hitting event;
determining for each of the player and the opponent a winning condition corresponding to at least one of an input speed for inputting the input signal and an input number of the input signal for winning the match in the consecutive hitting event;
determining the win/loss outcome in the consecutive hitting event based on the determined winning condition and changing a predetermined parameter related to the game progress so that one of either the player or the opponent that is determined to be a winner is given advantage over the other one of the player or the opponent that is determined to be a loser; and
generating screen data according to the game progress and outputting the generated screen data to a display.

8. A video game control method, comprising the steps of:
inputting a player operation input;
detecting that an operation input requesting condition has been satisfied for starting a win/loss determination by operation input based on a predetermined input condition and a predetermined winning condition;
detecting norm setting information that is based on a game progress at the time of detecting that the operation input requesting condition has been satisfied;
adjusting at least one of the predetermined input condition and the predetermined winning condition based on the detected norm setting information and determining at least one of an input condition and a winning condition;
controlling the game progress including a win/loss determination based on at least one of the determined input condition and the winning condition; and
generating screen data according to the game progress and outputting the generated screen data to a display.

9. A computer-readable program for controlling a video game which program, when executed by a computer, causes the computer to perform a process comprising the steps of:
inputting a player operation input;
controlling a game progress based on an input signal generated in the inputting step;
detecting at least one of a speed at which the input signal is input and a number of times the input signal is input;
determining a win/loss outcome of a match between a player and an opponent in a consecutive hitting event based on at least one of the speed at which the input signal is input and the number of times the input signal is input;
monitoring the game progress and detecting a start of the consecutive hitting event;
detecting a parameter indicating a game status at the time the start of the consecutive hitting event is detected, the parameter being used to determine superiority/inferiority of the player and the opponent in the consecutive hitting event;
determining for each of the player and the opponent a winning condition corresponding to at least one of an input speed for inputting the input signal and an input number of the input signal for winning the match in the consecutive hitting event;
determining the win/loss outcome in the consecutive hitting event based on the determined winning condition and changing a predetermined parameter related to the game progress so that one of either the player or the opponent that is determined to be a winner is given advantage over the other one of the player or the opponent that is determined to be a loser; and
generating screen data according to the game progress and outputting the generated screen data to a display.

10. A computer-readable program for controlling a video game which program, when executed by a computer, causes the computer to perform a process comprising the steps of:
inputting a player operation input;
detecting that an operation input requesting condition has been satisfied for starting a win/loss determination by operation input based on a predetermined input condition and a predetermined winning condition;
detecting norm setting information that is based on a game progress at the time of detecting that the operation input requesting condition has been satisfied;
adjusting at least one of the predetermined input condition and the predetermined winning condition based on the detected norm setting information and determining at least one of an input condition and a winning condition;
controlling the game progress including a win/loss determination based on at least one of the determined input condition and the winning condition; and
generating screen data according to the game progress and outputting the generated screen data to a display.
